(19) United States
(12) Patent Application Publication
(10) Pub. No.: US 2016/0075012 A1
(43) Pub. Date: Mar. 17, 2016

(54) MULTI-COMPONENT ROBOTIC HUB MOUNTING PLATE TO FACILITATE HUB REMOVAL

(71) Applicant: Fabworx Solutions, Inc., Austin, TX (US)

(72) Inventors: Michael Alan Dailey, Austin, TX (US); Eli Terry, Austin, TX (US); Thomas E. Walton, JR., Manor, TX (US)

(21) Appl. No.: 14/820,240

(22) Filed: Aug. 6, 2015

Related U.S. Application Data
(60) Provisional application No. 62/051,843, filed on Sep. 17, 2014.

(51) Int. Cl. B25J 9/04; F16H 49/00

(52) U.S. Cl. CPC B25J 9/041; F16H 49/00; B25J 9/042

(57) ABSTRACT

A robot is provided which includes a hub plate (205), and a rotatable hub (203) which is disposed on the hub plate and which has at least one robotic arm attached thereto. The hub plate includes a first component (207) which is attached to the hub, and a second component (209) which is attached to a substrate. The first component of the hub plate is releasably attached to the second component of the hub plate.

### CROSS-REFERENCE TO RELATED APPLICATION

This application claims the benefit of priority from U.S. Provisional Application No. 62/051,843 filed Sep. 17, 2014, having the same inventors, and the same title, and which is incorporated herein in its entirety.

### TECHNICAL FIELD OF THE INVENTION

The present invention pertains generally to robots for use in semiconductor fabrication, and more particularly, to a multi-component robotic hub mounting plate for use with such robots which facilitates hub removal.

### BACKGROUND OF THE INVENTION

In a typical semiconductor manufacturing process, a single wafer may be exposed to a number of sequential processing steps including, but not limited to, chemical vapor deposition (CVD), physical vapor deposition (PVD), etching, planarization, and ion implantation. These processing steps are typically performed by robots, due in part to the ability of robots to perform repetitive tasks quickly and accurately and to work in environments that are dangerous to humans.

Many modern semiconductor processing systems are centered around robotic cluster tools that integrate a number of process chambers. This arrangement allows multiple sequential processing steps to be performed on the wafer within a highly controlled processing environment, and thus minimizes exposure of the wafer to external contaminants. The combination of chambers in a cluster tool, as well as the operating conditions and parameters under which those chambers are utilized, may be selected to fabricate specific structures using a specific process recipe and process flow. Some commonly used process chambers include degas chambers, substrate pre-conditioning chambers, cool down chambers, transfer chambers, chemical vapor deposition chambers, physical vapor deposition chambers and etch chambers.

One example of a known cluster tool is disclosed in U.S. Pat. No. 6,222,337 (Kroeker et al.), which is reproduced in FIG. 1 herein. The cluster tool 10 disclosed therein features robots 14, 28 having a frog-leg construction. Such robots are adapted to provide both radial and rotational movement of their associated end effector blades 17 within a fixed plane. These radial and rotational movements may be coordinated or combined to allow wafers 32 to be picked up, transferred and delivered from one processing chamber to another processing chamber within the cluster tool 10.

With reference to FIG. 1, wafers are introduced into, and withdrawn from, the cluster tool 10 through a cassette loadlock 12. In the particular cluster tool depicted, a first robot 14 having a wafer plate blade 17 end effector is located within a chamber 18 and is utilized to transfer wafers 32 among a first set of processing chambers. In the particular embodiment depicted, these processing chambers include the aforementioned cassette loadlock 12, a degas wafer orientation chamber 20, a preclean chamber 24, a PVD TiN chamber 22 and a cooldown chamber 26. The robot 14 is illustrated in the retracted position in which it can rotate freely within transfer chamber 18.

A second robot 28 is located in transfer chamber 30 and is adapted to transfer substrates between a second set of process chambers. In the particular embodiment depicted, the second set of process chambers includes a cool down chamber 26 and a pre-clean chamber 24, and may also include a CVD Al chamber and a PVD AlCu processing chamber. The specific configuration of chambers in the cluster tool 10 is designed to provide an integrated processing system capable of both CVD and PVD processes in a single tool. A microprocessor controller 29 is provided to control the fabricating process sequence, conditions within the cluster tool, and the operation of the robots 14, 28.

FIG. 2 depicts an example of a robot which may be used in the cluster tool of FIG. 1. The particular robot 101 depicted in FIG. 2 has a double frog-leg design and features first 103 and second 105 pairs of arms which are attached on one end to a wrist assembly 107, and which are attached on the other end to an elbow joint 109. Each wrist assembly 107 is in turn attached to an end effector 111 which is used to handle a semiconductor wafer. The robot 101 is further equipped with upper arms 113, 115 which are mounted on the upper 117 and lower 119 rotatable rings of a hub 121. The robot 101 further comprises a monolithic hub plate 123 upon which the hub 121 is mounted, and a motor 125 which drives the upper 117 and lower 119 rotatable rings. The hub 121 and hub plate 123 together constitute a hub assembly 124.

As seen in FIG. 3, the robot 102 is mounted on the substrate 131 such that the hub plate 123 is attached to a first surface of the substrate 131. The motor 125 (see FIG. 2) typically extends below the substrate 131 through a hole provided therein.

### SUMMARY OF THE INVENTION

In one aspect, a robot is provided which comprises (a) a hub plate, and (b) a rotatable hub disposed on said hub plate and having at least one robotic arm attached thereto. The hub plate includes a first component which is attached to the hub, and a second component which is attached to a substrate. The first component of the hub plate is releasably attached to the second component of the hub plate.

In another aspect, a robot is provided which comprises (a) a hub plate; and (b) a rotatable hub disposed on said hub plate and having at least one robotic arm attached thereto. The hub plate is equipped with a first generally planar, circumferential surface equipped with a first plurality of holes through which a first set of releasable fasteners extend. The hub plate is further equipped with a second planar, circumferential surface equipped with a second plurality of holes through which a second set of releasable fasteners extend. The hub plate is also equipped with a toroidal surface disposed between said first and second circumferential surfaces which is complimentary in shape to the adjacent surface of said hub.

### BRIEF DESCRIPTION OF THE DRAWINGS

For a more complete understanding of the present invention and the advantages thereof, reference is now made to the following description taken in conjunction with the accompanying drawings in which like reference numerals indicate like features.

FIG. 1 is an illustration of a prior art cluster tool equipped with a robotic wafer handling system.

FIG. 2 is an illustration of a prior art robot which may be used in the cluster tool of FIG. 1.

FIG. 3 is an illustration of an embodiment of the robot of FIG. 2 shown mounted on a substrate.

FIG. 4 is a perspective view of a particular, non-limiting embodiment of a hub assembly equipped with a two-part hub plate of the type disclosed herein.

FIG. 5 is a perspective view showing the top of the first element of the hub assembly of FIG. 4.

FIG. 6 is a perspective view showing the top of the second element of the hub assembly of FIG. 4.

FIG. 7 is a top view of the first element of the hub assembly of FIG. 4.

FIG. 8 is a bottom view of the first element of the hub assembly of FIG. 4.

FIG. 9 is a top view of the second element of the hub assembly of FIG. 4.

FIG. 10 is a bottom view of the second element of the hub assembly of FIG. 4.

FIG. 11 is an exploded view of the hub assembly of FIG. 4.

FIG. 12 is a bottom view of the hub assembly of FIG. 4 showing the attachment of the lower plate to the robotic hub.

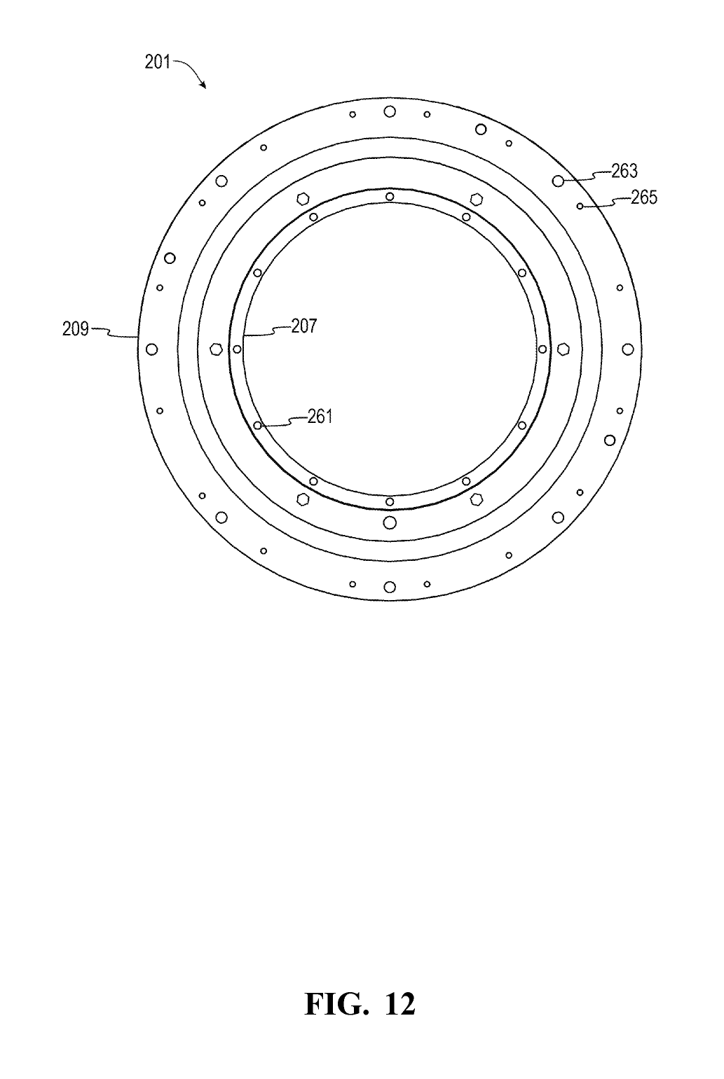

FIG. 13 is a perspective view of the hub assembly of FIG. 4 depicting the attachment of the lower plate to the robotic hub.

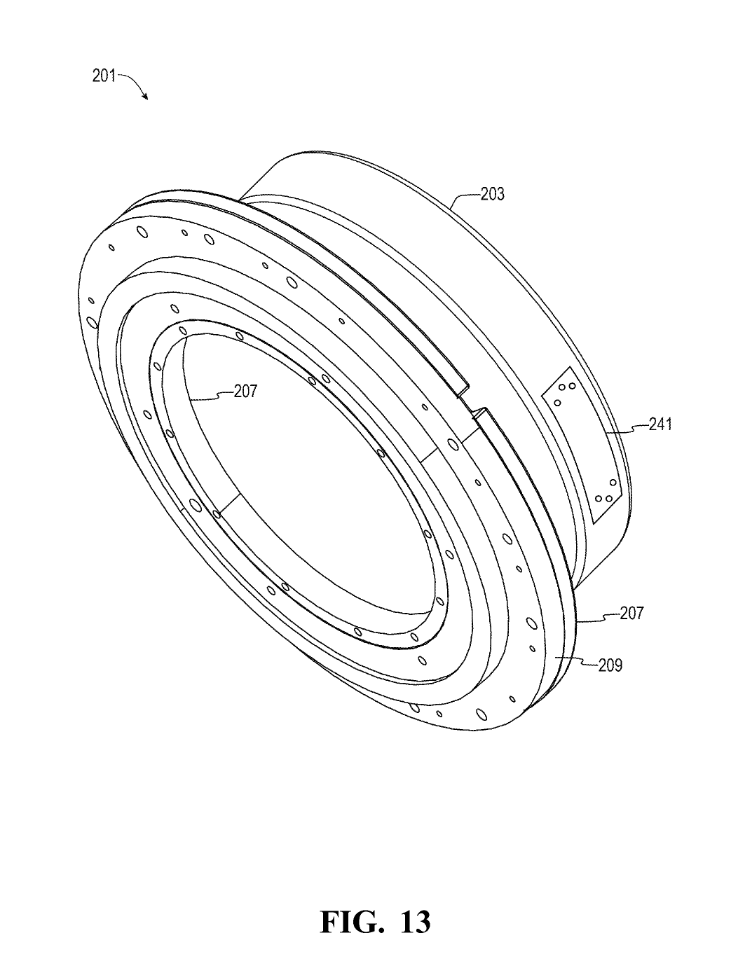

FIG. 14 is a partially exploded, perspective view of the hub assembly of FIG. 4 depicting the placement of the upper plate to lower plate fasteners.

FIG. 15 is a partially exploded, perspective view of the hub assembly of FIG. 4 depicting the disposition of the O-ring in the assembly.

FIG. 16 is a cross-sectional illustration of the hub assembly of FIG. 4 compared to a cross-sectional illustration of a prior art hub assembly and showing the increased material in the former in comparison to the latter.

FIG. 17 is a magnified view of REGION A of FIG. 6 showing the alignment marks thereon.

FIG. 18 is an illustration of a tool which may be utilized to remove the hub from a hub assembly of the type depicted in FIG. 4.

### DETAILED DESCRIPTION OF THE INVENTION

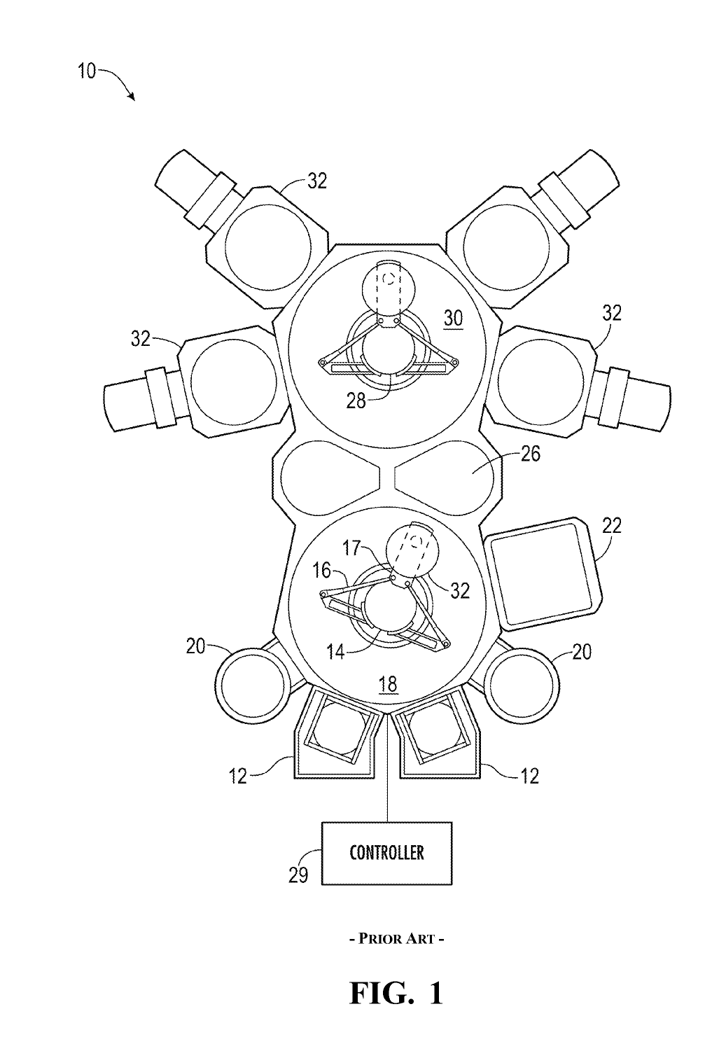

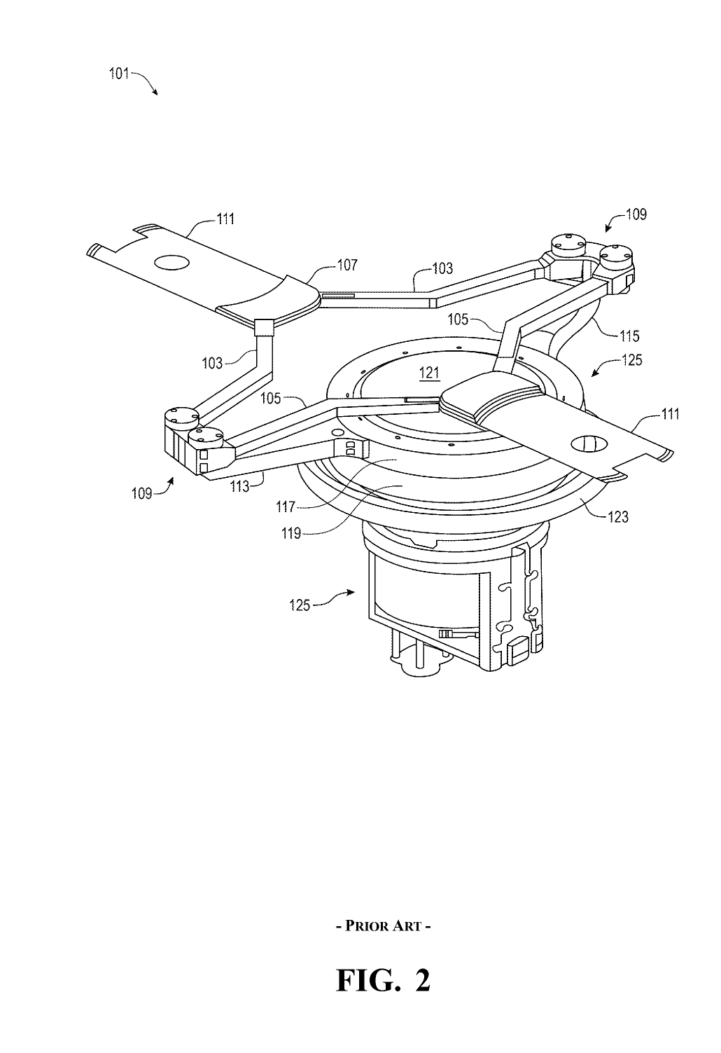

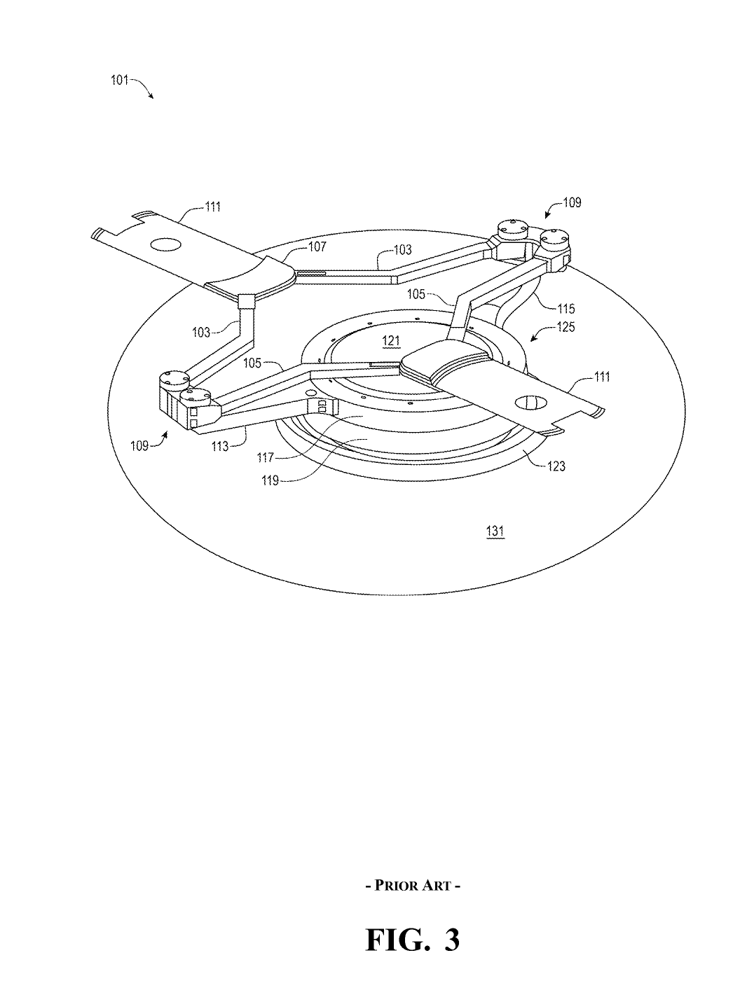

While robots of the type depicted in FIGS. 1-3 have some advantages, they also have some significant shortcomings. For example, it is frequently necessary to remove the hub 121 in order to service such robots, which in turn requires removal of the hub plate 123. However, removal of the hub plate 123 typically requires access to the underside of the tool. In a typical cluster tool, access to the area underneath of the hub 121 is typically restricted, due in part to the tight confinements of the mounting hardware. Consequently, at present, hub removal entails a considerable expenditure of time and effort. Indeed, removal and reinstallation of the hub 121 typically takes at least 1-2 hours. Given the significant cost that is frequently associated with semiconductor line downtime, the existing hub plate design represents a considerable hidden cost for semiconductor manufacturers.

The removal or reinstallation of the hub plate 123 also poses significant ergonomic risks for technicians involved in the process. In particular, when coupled with the cramped space underneath the tool, the existing hub plate design causes workers to assume awkward positions and to undertake uncomfortable maneuvers in order to access and remove or reinstall the mounting screws for the hub plate. In such a removal or reinstallation, the worker's lower body, neck, arms and hands may all be placed in uncomfortable positions and movements for extended periods of time, which may result in strains and injury.

In addition, the removal or reinstallation of the hub plate 123 frequently results in damage to surrounding hardware in the chambers and tool. Typically, a technician is forced to enter the lower portion of a chamber in order to access the mounting screws. During the removal or reinstallation process, the technician is often forced to lie on gas lines, harnesses, waterlines and high voltage RF and AC cables. Consequently, the likelihood of collateral damage is high each time the removal or reinstallation process is undertaken.

It has now been found that the foregoing problems may be overcome with the hub plate design disclosed herein. In a preferred embodiment, this hub plate has a 2-component design in which the first (upper) component is attached to the hub, the second (lower) component is attached to the substrate, and the first component is removably attached to the second component. Consequently, removal of the hub only requires detaching the first component from the second component, which may be accomplished by removing a series of screws accessible from above the substrate (e.g., from the inside of the buffer chamber). Since these screws are readily accessible and are not in a space-constrained location, hub removal may be accomplished much faster compared to conventional hub plates, and without the ergonomic issues and risk of collateral damage noted above.

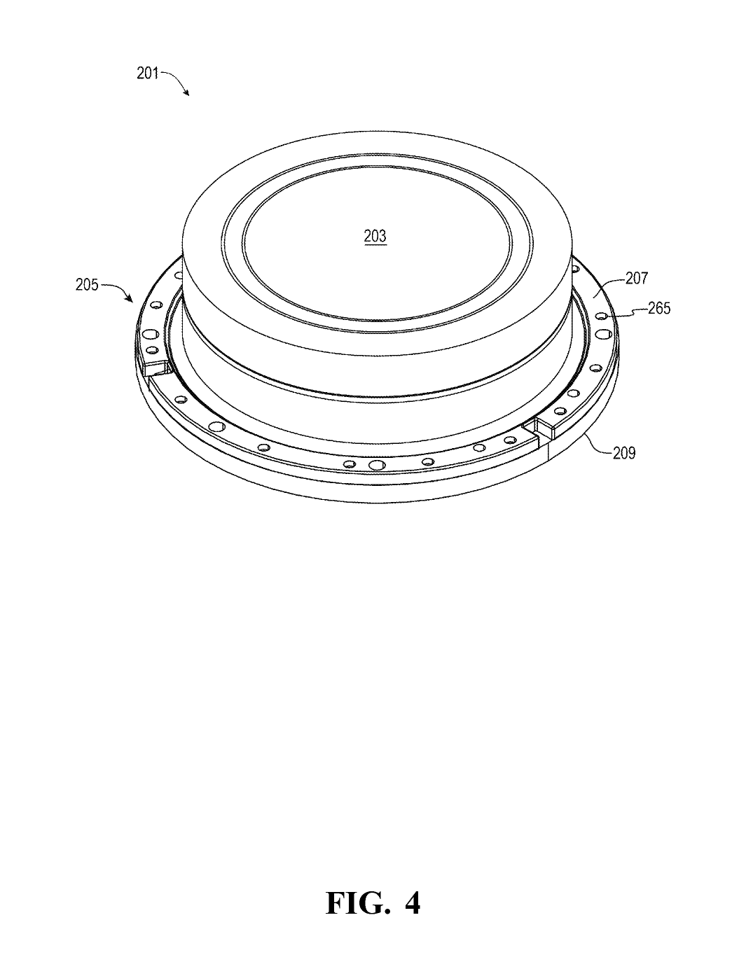

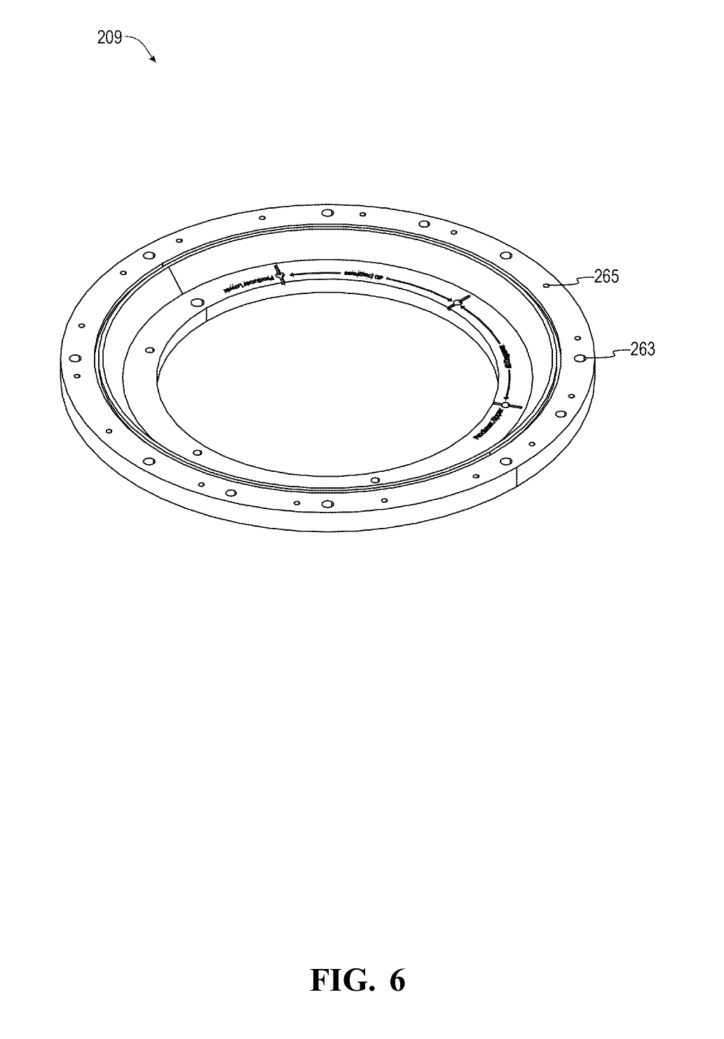

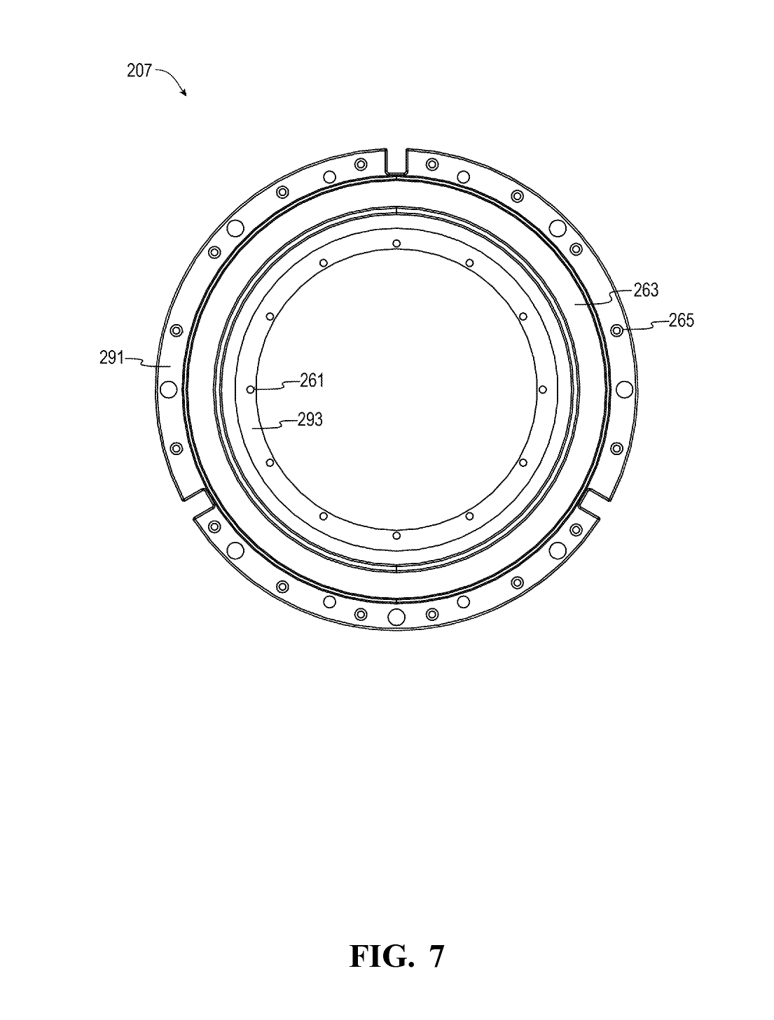

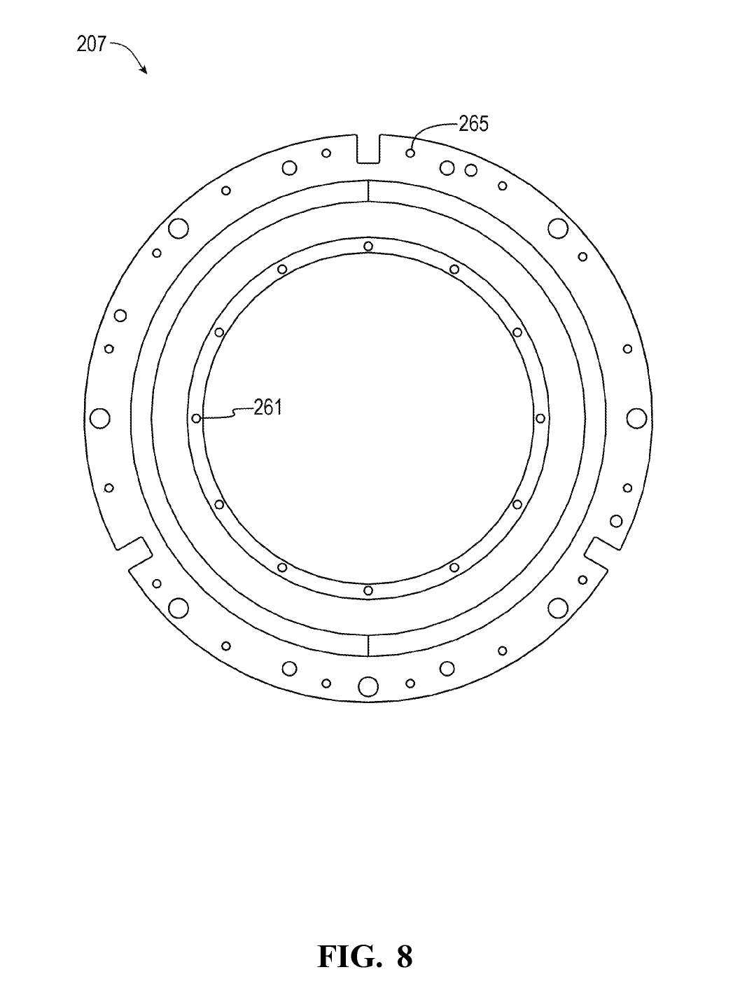

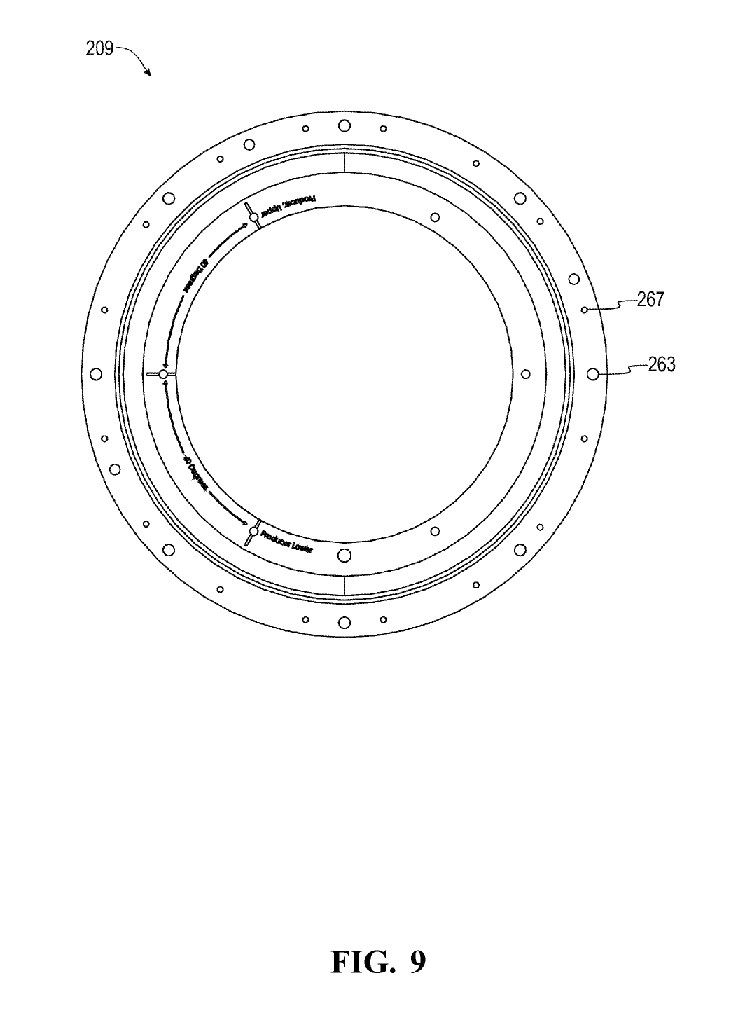

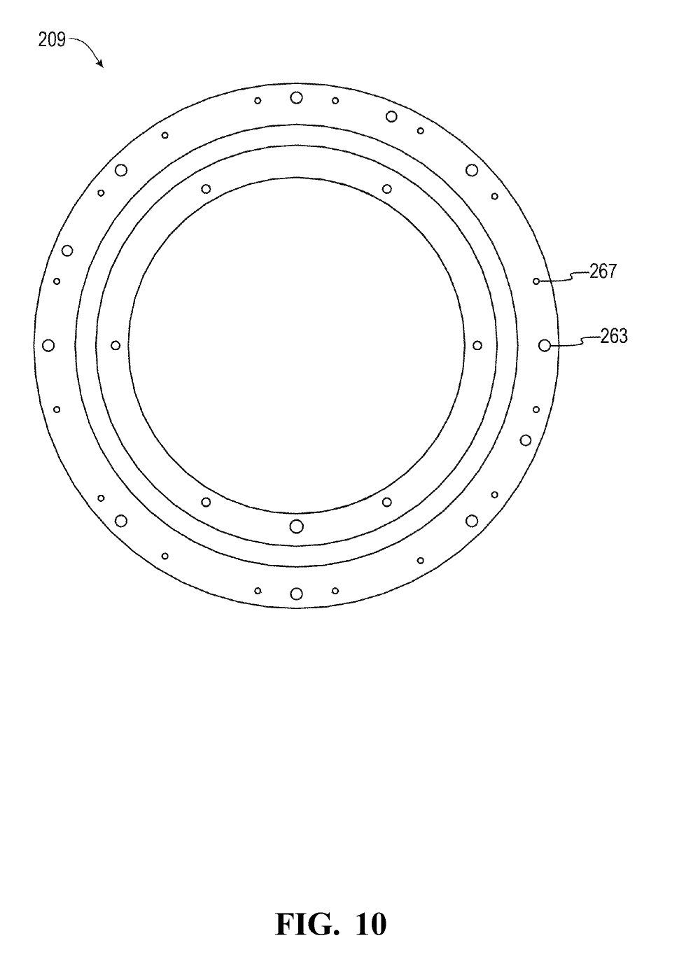

FIG. 4 depicts a particular, non-limiting embodiment of a hub assembly equipped with a hub plate in accordance with the teachings herein. This hub assembly 201 is designed to be interchangeable with the hub assembly 125 in the robot of FIGS. 1-3. The hub assembly 201 comprises a hub 203 and a two-part hub plate 205 having first 207 and second 209 components. The first component 207 of the hub plate 205 is shown in greater detail in FIGS. 7 and 8, and the second component 209 of the hub plate 205 is shown in greater detail in FIGS. 6, 9 and 10.

In a preferred embodiment, the dimensions of the hub plate 205 are comparable to the dimensions of the hub plate 123 of FIG. 4, thus allowing the former to be substituted for the later in legacy platforms. The hub plate 205 in this particular embodiment is suitable for use in 200 mm and 300 mm legacy and EHubs in Centura, Producer and Endura platforms, although it will be appreciated that similar hub plates may be made in accordance with the teachings herein that may be utilized with other robots and platforms.

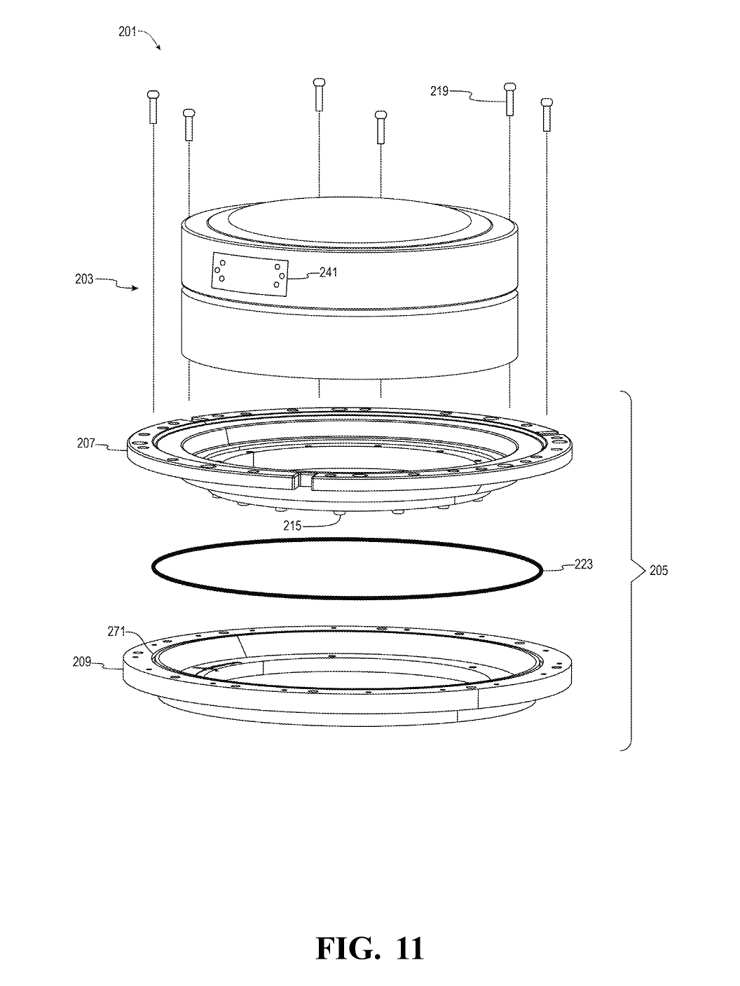

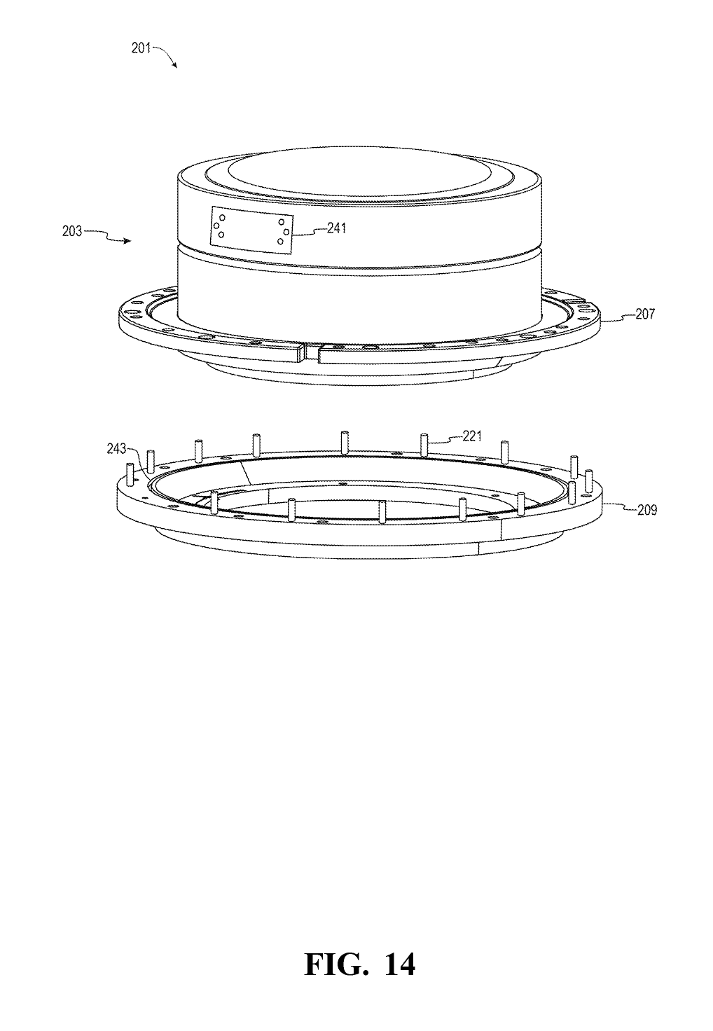

FIG. 11 is a partially exploded view of the hub assembly 201 of FIG. 4. As seen therein, the first component 207 of the hub plate 205 is attached to the underside of the hub 203 by way of a first set of fasteners 215 which extend through holes 261 (see FIGS. 7 and 8), the second component 209 of the hub plate 205 is attached to the first component 207 of the hub plate 205 by way of a second set of fasteners 219 which extend through holes 263 (see FIGS. 6, 9 and 10), and the second component 209 of the hub plate 205 is attached to a substrate (typically, a chamber bottom) by way of a third set of fasteners 221 (see FIG. 14) which extend through holes 265 (see FIGS. 7-8) and 267 (see FIGS. 6, 9 and 10).

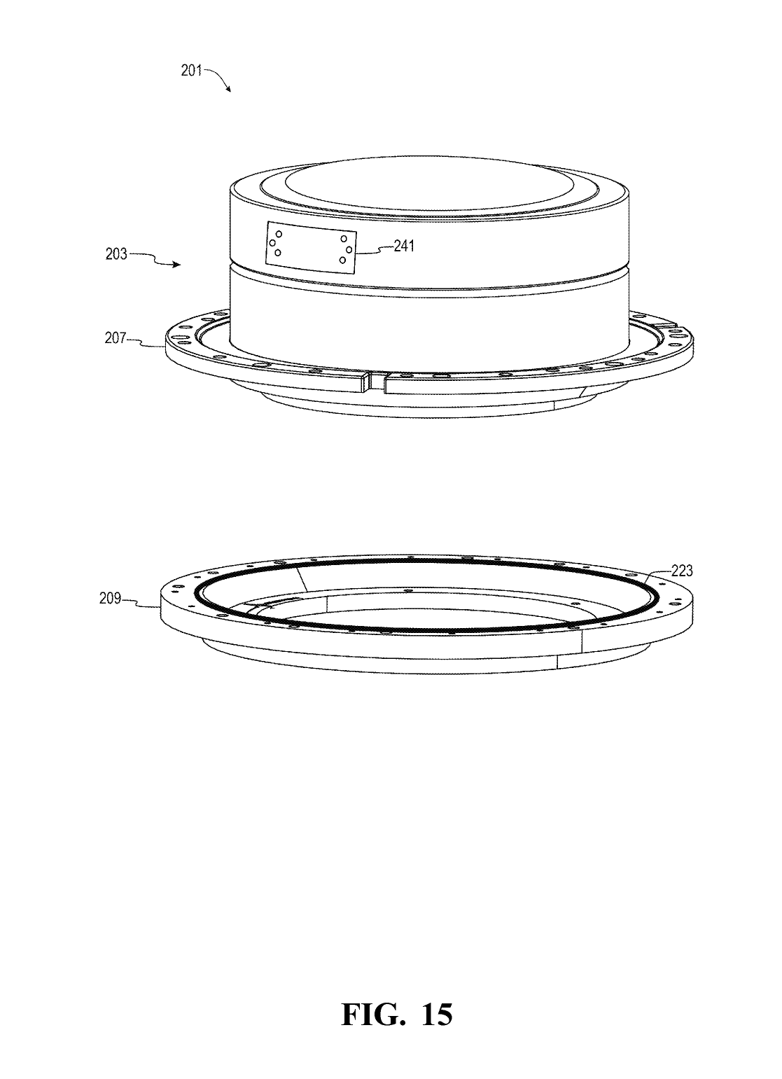

As seen in FIG. 11, an O-ring 223 is disposed between the first 207 and second 209 components of the hub plate 201 to allow a vacuum seal to be maintained therein. The O-ring 223 preferably comprises a resilient material such as, for example, nitrile rubber, butyl rubber or PTFE (polytetrafluoroethylene), and is seated in a circumferential, complimentary-shaped groove 271 in the second component 209. FIG. 15 depicts the O-ring 223 seated in circumferential groove 271 (see FIG. 11) of the second 209 components of the hub plate 201.

It will be appreciated from FIG. 11 that the design of the hub plate 205 allows the hub 203 to be removed from a substrate by removal of the second set of fasteners 219. Doing so detaches the first 207 and second 209 components of the hub plate 205 from each other, but leaves the second component 209 of the hub plate 205 attached to the substrate, and the first component 207 of the hub plate attached to the hub 205. It will further be appreciated that this removal may be accomplished from above the substrate, where accessibility to the third set of fasteners 221 is typically unhindered (although embodiments are also possible in which such removal may be accomplished from below the substrate, or from both above and below the substrate). Consequently, the two-pat hub plate 205 disclosed herein may be utilized in a platform to overcome the various issues in the art as noted above.

In the particular embodiment depicted in FIG. 11, six fasteners 219 are utilized to attach the second component 209 of the hub plate 205 to the first component 207 of the hub plate 205, and twelve 8-32 fasteners 215 are utilized to attach first component 207 of the hub plate 205 to the hub 213. As seen in FIG. 14, fifteen 8-32 fasteners 221 are utilized to attach the second component 209 of the hub plate 205 to the substrate. As noted above, the fasteners 219 can be removed from the top of the tool, and hence allow removal of the hub 213 from the top of the tool. Preferably, the first 215, second 219 and third 221 sets of fasteners are threaded fasteners which rotatingly engage complimentary shaped threaded apertures. Thus, the first set of fasteners 215 preferably rotatingly engage apertures 261, the second set of fasteners 219 preferably rotatingly engage apertures 265 and 267, and the third set of fasteners 221 preferably rotatingly engage apertures 263 and/or rotatingly engage threaded apertures provided in the substrate.

FIGS. 14-15 show the placement of the O-ring 223 on the second component 209 of the hub plate 205. A complimentary shaped groove 243 (see FIG. 14) is provided in the second component 209 within which the O-ring 223 is seated (see FIG. 15). The hub plate 205 separates the transfer chamber from the atmosphere. The O-ring 223 thus serves to maintain the integrity of this seal across the interface between the first 207 and second 209 components. In addition, three alignment pins (not shown) are provided in the second component 209 of the hub plate 205 to ensure proper alignment between the first 207 and second 209 components of the hub plate 205.

As noted above, the hub plates disclosed herein may be frequently utilized to replace hub plates in legacy equipment. In such applications, it is desirable for the two-piece hub plate to have equivalent structural integrity to the Original Equipment Manufacturer (OEM) hub plate. However, fabricating the hub plate as a multicomponent structure may reduce the structural integrity of the hub plate as compared to the monolithic OEM structure. While this problem may be addressed by increasing the overall dimensions of the hub plate (e.g., by increasing the thickness of the hub plate components), such an approach is unacceptable in applications where the hub plate is to be utilized for replacement of an OEM hub plate, since the hub plate design is subject to constraints in several directions. It will thus be appreciated that strengthening a two-piece hub plate, while preserving its ability to be utilized in legacy platforms, is not trivial.

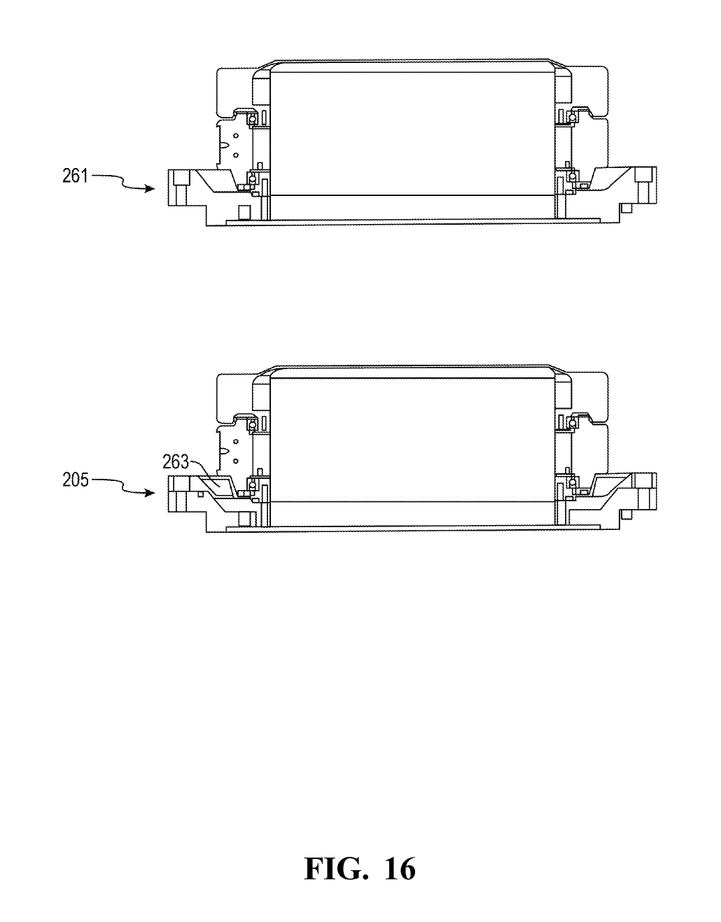

In the preferred embodiment of the hub plate 205 depicted in FIG. 4, this issue is addressed through the selective addition of material to the hub plate as compared to the OEM hub. The manner in which this is accomplished may be appreciated with respect to FIG. 16, which compares the cross-sectional profile of a hub plate 205 in accordance with the teachings herein with that of an OEM hub plate 261. As seen therein, the first component 207 of the hub plate 205 has a different cross-sectional profile as compared to the OEM hub plate 261. This difference in profiles results from the addition of a toroid of material 263 to the inner rim of first component 207 of the hub plate 205, while the corresponding OEM hub plate 261 has an open space in this region. This toroid 263 significantly strengthens the entire hub plate structure, which may thus compensate for any loss in mechanical integrity attendant to the division of the hub plate 205 into multiple components. At the same time, the added toroid of material does not interfere with other components of the hub assembly (that is, in every other respect, the two-part hub plate 205 has the same overall dimensions as the legacy OEM hub plate 261), and is thus suitable for OEM hub plate replacement applications.

The profile of the first component 207 of the hub plate 205 has the additional benefit of helping to contain any particles that may be generated by the lower hub bearing. As seen in FIG. 7, this profile includes a first generally planar circumferential surface 291 having apertures 265 therein, a second generally planar circumferential surface 293 having apertures 261 therein, and a toroidal surface 263 disposed between the first 291 and second 293 circumferential surfaces which is complimentary in shape to the adjacent surface of said hub. While this profile is especially advantageous within the context of the two-part hub plate 205 of the type described herein, one skilled in the art will appreciate that this profile may also be utilized in monolithic hub plates, where benefits of improved mechanical strength and containment of particles generated by the lower hub bearing may also be achieved.

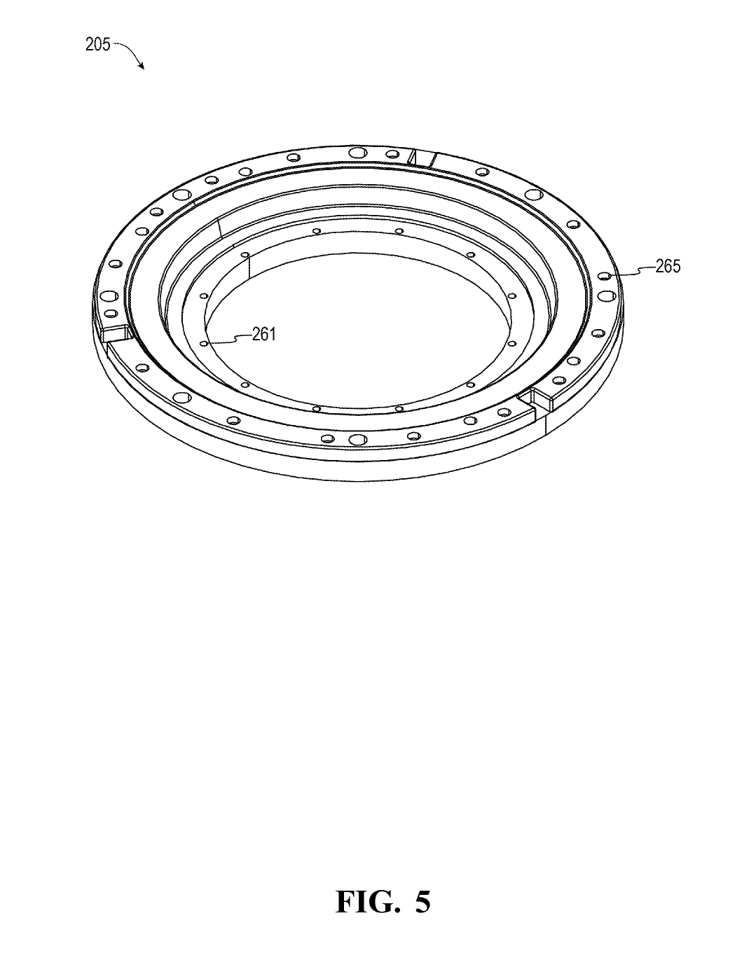

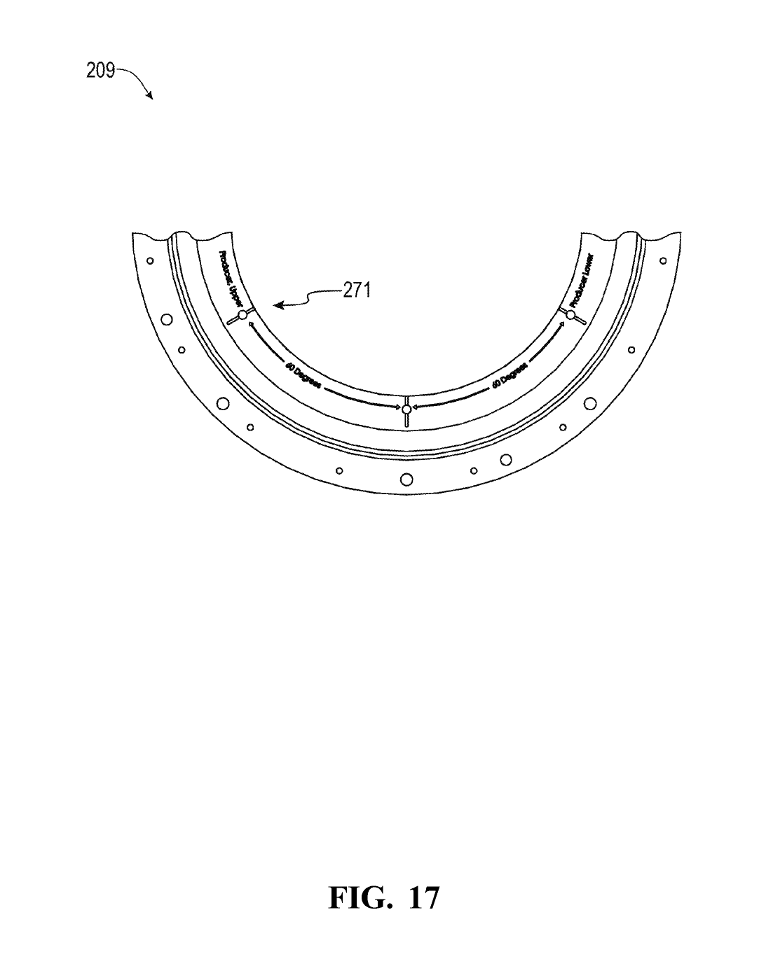

FIG. 17 depicts further details of the second component 209 of the hub plate 205 of FIG. 5. As seen therein, the second component 209 of the hub plate 205 is equipped with alignment marks 271. These alignment marks 271 may be utilized to align the magnetic couplers of the hub 213.

In an assembled condition, the first 207 and second 209 components of the hub plate 205 described herein are preferably parallel to each other within a tolerance range that is equal to or greater than that of the OEM hub plate it is replacing. This objective may be achieved by utilizing a stress relieved aluminum alloy as the base material, together with geometric tolerancing of the manufacturing drawings.

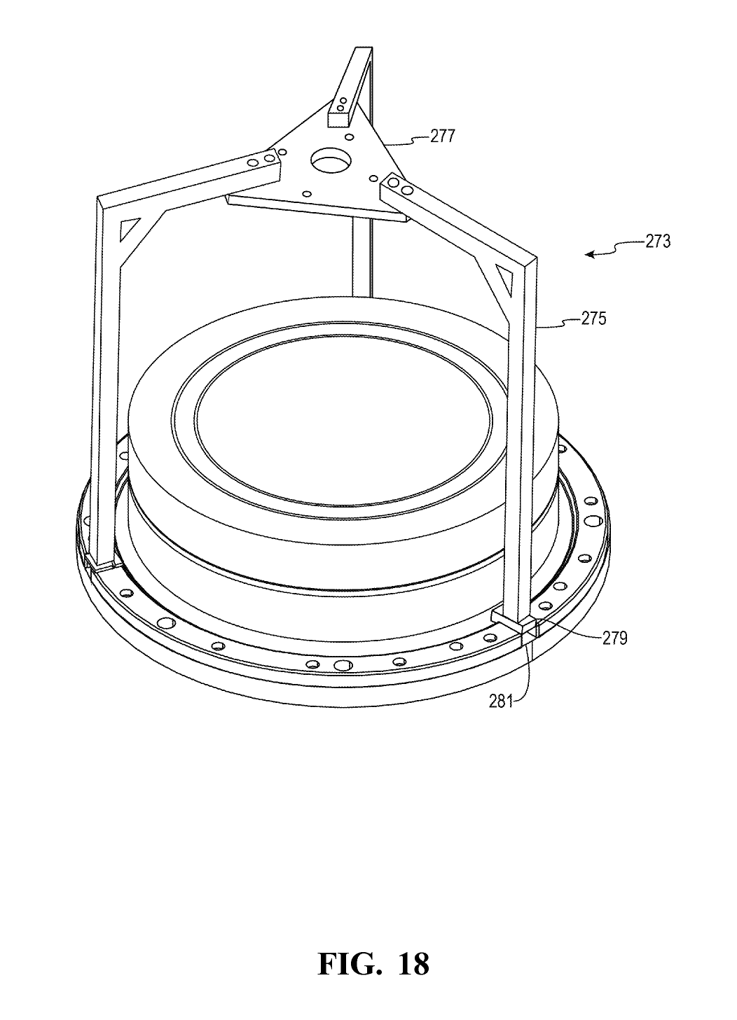

FIG. 18 depicts a hub removal tool which may be utilized in conjunction with the hub plates disclosed herein. As seen therein, the hub removal tool 273 comprises a plurality of legs 275 which are adjoined at one end with a central plate 277, and which terminate on the other end in feet 279 that engage complimentary-shaped openings 281 provided in the first component 207 of the hub plate 205. Preferably, the complimentary-shaped openings 281 are sufficiently small that they do not encroach on the areas needed to form a seal with the O-ring 223.

In some embodiments, the hub removal tool 273 may be utilized in conjunction with rotary tools (not shown) that attach to the central plate 277 and the hub, and which use a threaded axis to lift the hub from the substrate along an axis which is perpendicular to the substrate. In use, after the requisite fasteners have been removed, the hub removal tool 273 may be attached to the hub 213 by engaging the feet 279 of the tool with the complimentary-shaped openings 281 provided in the first component 203, after which it may be utilized, alone or with another tool, to remove the hub 213.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

what is claimed is:

1. A robot, comprising:
a hub plate; and
a rotatable hub disposed on said hub plate and having at least one robotic arm attached thereto;
wherein said hub plate includes a first component which is attached to said hub, and a second component which is attached to a substrate, and wherein said first component of said hub plate is releasably attached to said second component of said hub plate.

2. The robot of claim 1, further comprising an O-ring disposed between said first and second components of said hub plate.

3. The robot of claim 2, further comprising a circumferential groove on a surface of said second component of said hub plate, wherein said O-ring is seated in said circumferential groove.

4. The robot of claim 1, wherein said first component of said hub plate is equipped with a first plurality of holes through which a first set of releasable fasteners extend.

5. The robot of claim 4, wherein said second component of said hub plate is equipped with a first set of threaded apertures, and wherein each of said first set of releasable fasteners rotatably engages one of said first set of threaded apertures.

6. The robot of claim 1, wherein said second component of said hub plate is equipped with a second plurality of holes through which a second set of releasable fasteners extend.

7. The robot of claim 6, wherein said substrate is equipped with a second set of threaded apertures, and wherein each of said second set of releasable fasteners rotatably engages one of said second set of threaded apertures.

8. The robot of claim 1, wherein said first component of said hub plate is equipped with a third plurality of holes through which a third set of releasable fasteners extend.

9. The robot of claim 8, wherein said hub is equipped with a third set of threaded apertures, and wherein each of said third set of releasable fasteners rotatably engages one of said third set of threaded apertures.

10. The robot of claim 1, wherein said at least one robotic arm includes first and second arms arranged in a frog-leg configuration.

11. The robot of claim 10, wherein said first and second arms are attached on a first end thereof to a first wrist assembly.

12. The robot of claim 11, wherein said wrist assembly has a wafer blade attached thereto.

13. The robot of claim 10, wherein said at least one robotic arm further includes third and fourth arms arranged in a frog-leg configuration.

14. The robot of claim 13, wherein said third and fourth arms are attached on a first end thereof to a second wrist assembly.

15. The robot of claim 14, wherein said first and second arms are attached on a second end thereof to a first elbow assembly, and wherein said third and fourth arms are attached on a second end thereof to a second elbow assembly.

16. The robot of claim 15, further comprising first and second lower arms, wherein a first end of said first lower arm is attached to said first wrist assembly, wherein a second end of said first lower arm is attached to said hub, wherein a first end of said second lower arm is attached to said first wrist assembly, and wherein a second end of said second lower arm is attached to said hub.

17. A cluster tool comprising the robot of claim 1.

18. The robot of claim 1, wherein said hub plate is mounted on a substrate.

19. The robot of claim 18, wherein said first component of said hub plate is equipped with a first, a second and a third plurality of holes through which first, second and third sets of releasable fasteners respectively extend, wherein said first set of releasable fasteners secure said first component of said hub plate to said hub, wherein said second set of releasable fasteners secure said second component of said hub plate to said substrate, and wherein said third set of releasable fasteners secure said second component of said hub plate to said first component of said hub plate.

20. The robot of claim 19, wherein said third set of releasable fasteners are removable from the side of the substrate upon which the hub plate is mounted.

21. The robot of claim 1, wherein said first component of said hub plate is equipped with a first generally planar, circumferential surface equipped with a first plurality of holes through which a first set of releasable fasteners extend, wherein said first component of said hub plate is further equipped with a second planar, circumferential surface equipped with a second plurality of holes through which a second set of releasable fasteners extend, and wherein said first component of said hub plate is further equipped with a toroidal surface disposed between said first and second circumferential surfaces which is complimentary in shape to the adjacent surface of said hub.

22. A robot, comprising:
a hub plate; and
a rotatable hub disposed on said hub plate and having at least one robotic arm attached thereto;
wherein said hub plate is equipped with a first generally planar, circumferential surface equipped with a first plurality of holes through which a first set of releasable fasteners extend, wherein said hub plate is further equipped with a second planar, circumferential surface equipped with a second plurality of holes through which a second set of releasable fasteners extend, and wherein said hub plate is further equipped with a toroidal surface disposed between said first and second circumferential surfaces which is complimentary in shape to the adjacent surface of said hub.

23. The robot of claim 22, wherein said second set of releasable fasteners attach said hub plate to said hub.
